(19) United States
(12) Patent Application Publication
(10) Pub. No.: US 2016/0323777 A1
(43) Pub. Date: Nov. 3, 2016

(54) METHOD AND APPARATUS FOR SUPPORTING UE-TO-NETWORK RELAY BASED ON DEVICE TO DEVICE SERVICE IN A WIRELESS COMMUNICATION SYSTEM

(71) Applicant: ASUSTeK Computer Inc., Taipei City (TW)

(72) Inventors: Li-Te Pan, Taipei City (TW); Wei-Yu Chen, Taipei City (TW)

(21) Appl. No.: 15/136,529

(22) Filed: Apr. 22, 2016

Related U.S. Application Data
(60) Provisional application No. 62/153,796, filed on Apr. 28, 2015.

(51) Int. Cl. H04W 28/06; H04W 72/04; H04W 4/02

(52) U.S. Cl. CPC H04W 28/065; H04W 4/02; H04W 72/0453

(57) ABSTRACT

A method and apparatus for supporting UE-to-Network relay based on device to device service in a wireless communication system. In one embodiment, the method includes that a first UE is configured with at least a first set of logical channel(s) and a second set of logical channel(s). The method further includes the first UE transmitting a transport block (TB) including at least a Medium Access Control (MAC) subheader, which is including at least a LCID field to set a specific value, and a MAC Service Data Unit (SDU) to a base station, wherein the MAC subheader is used to indicate a logical channel which is associated with the MAC SDU belonging to the first set of logical channel(s) or the second set of logical channel(s).

### CROSS-REFERENCE TO RELATED APPLICATIONS

The present application claims the benefit of U.S. Provisional Patent Application Ser. No. 62/153,796 filed on Apr. 28, 2015, the entire disclosure of which is incorporated herein by reference.

### FIELD

This disclosure generally relates to wireless communication networks, and more particularly, to a method and apparatus for supporting UE-to-Network relay based on device to device service in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus for supporting UE-to-Network relay based on device to device service in a wireless communication system. In one embodiment, the method includes that a first UE is configured with at least a first set of logical channel(s) and a second set of logical channel(s). The method further includes the first UE transmitting a transport block (TB) that includes at least a MAC (Medium Access Control) subheader with at least a LCID (Logical Channel Identity) field to set a specific value, and a MAC SDU (Service Data Unit) to a base station, wherein the MAC subheader is used to indicate a logical channel which is associated with the MAC SDU belonging to the first set of logical channel(s) or the second set of logical channel(s).

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of Figure 6.3.3.1-1 of 3GPP TR 23.703 v12.0.0.

FIG. 6 is a reproduction of Figure 6.3.3.2-1 of 3GPP TR 23.703 v12.0.0.

FIG. 7 is a reproduction of Figure 7.2.1.2-1 of 3GPP TR 23.713 v0.3.0.

FIG. 8 is a reproduction of Figure 7.2.2-1 of 3GPP TR 23.713 v0.3.0.

FIG. 9 is a reproduction of Figure 7.2.2.2-1 of 3GPP TR 23.713 v0.3.0.

FIG. 10 is a reproduction of Figure 7.2.2.3-1 of 3GPP TR 23.713 v0.3.0.

FIG. 11 is a reproduction of Figure 5.4.2-1 of 3GPP TR 23.303 v12.3.0.

FIG. 12 is a reproduction of Figure 5.4.3-1 of 3GPP TR 23.303 v12.3.0.

FIG. 13 is a reproduction of Table-1 of 3GPP R2-151326.

FIG. 14 is a reproduction of Table-2 of 3GPP R2-151326.

FIG. 15 is a reproduction of Table 4.8.2.1.7-1 of 3GPP TS 36.508 v12.5.0.

FIG. 16 is a reproduction of Figure 6.1.2-1 of 3GPP TS 36.321 v11.2.0.

FIG. 17 is a reproduction of Figure 6.1.2-2 of 3GPP TS 36.321 v11.2.0.

FIG. 18 is a reproduction of Figure 6.1.2-3 of 3GPP TS 36.321 v11.2.0.

FIG. 19 is a reproduction of Table 6.2.1-1 of 3GPP TS 36.321 v11.2.0.

FIG. 20 is a reproduction of Table 6.2.1-2 of 3GPP TS 36.321 v11.2.0.

FIG. 21 is a reproduction of Table 6.2.1-3 of 3GPP TS 36.321 v11.2.0.

FIG. 22 illustrates an example of association between Uu logical channel, radio bearer, and EPS (Evolved Packet System) bearer according to one exemplary embodiment.

FIG. 23 illustrates an exemplary embodiment.

FIG. 24 illustrates an exemplary embodiment.

FIG. 25 is a flow chart according to one exemplary embodiment.

FIG. 26 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support the wireless technology discussed in the various documents. Furthermore, the exemplary wireless communication systems devices described below may be designed to support one or more standards such as the standard offered by a consortium named “3rd Generation Partnership Project” referred to herein as 3GPP, including: SP-110638, “Study on Proximity-based Services”; RP-142311, “Work Item Proposal for Enhanced LTE Device to Device Proximity Services”; TR 23.703 v12.0.0, “Study on architecture enhancements to support Proximity-based Services (ProSe)”; TR23.303 v12.3.0, “Proximity-based services (ProSe); Stage 2”; TS 36.331 v11.4.0, “Radio Resource Control (RRC); Protocol specification”; TS 23.107 v12.0.0, “Quality of Service (QoS) concept and architecture”; TS 36.508 v12.5.0, “Common test environments for User Equipment (UE) conformance testing”; TS 36.321 v11.2.0, “Medium Access Control (MAC) protocol specification”; TR 23.713 v0.3.0, “Study on extended architecture support for Proximity-based services (Release 13)”; R2-151326, “Protocol Stack for UE-to-Network Relay”; and R2-151290, “Issues to support UE2NW relay UE in D2D communication”. The standards and documents listed above are hereby expressly incorporated by reference in their entirety.

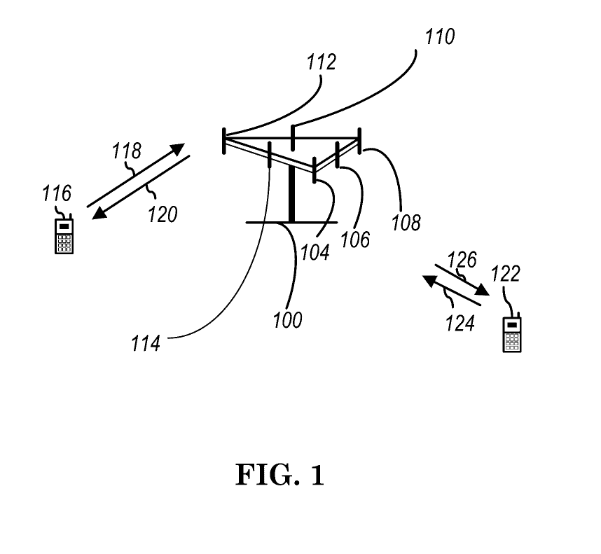

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), or some other terminology. An access terminal (AT) may also be called user equipment (UE), a wireless communication device, terminal, access terminal or some other terminology.

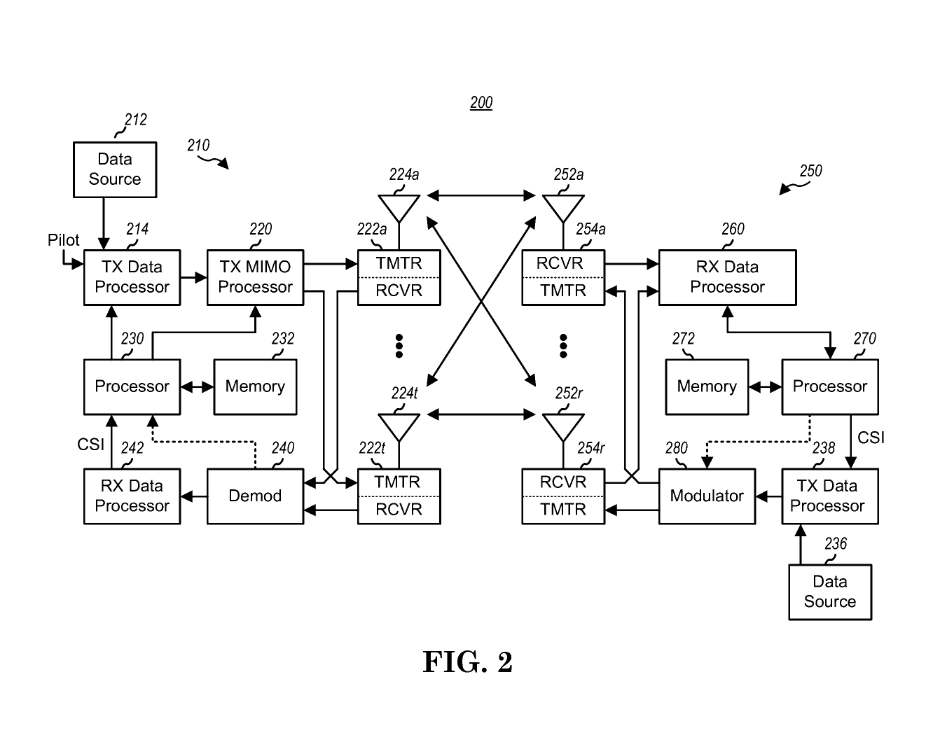

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

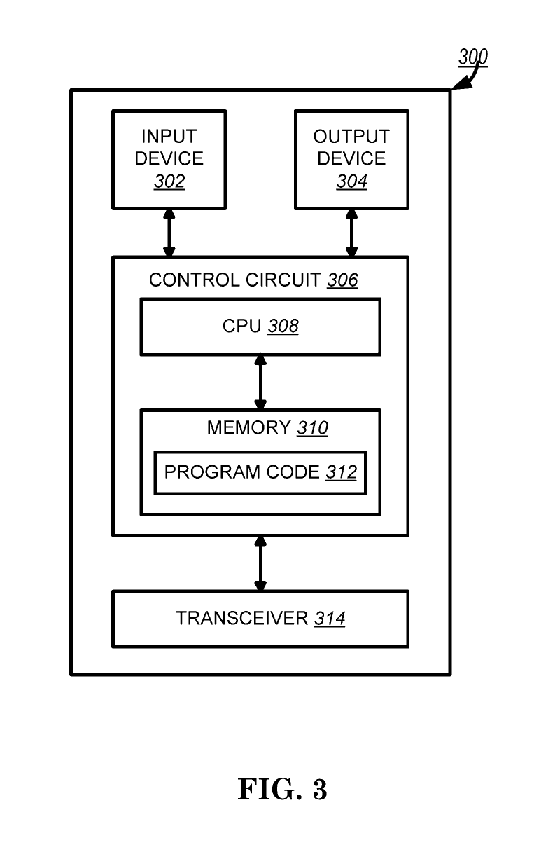

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

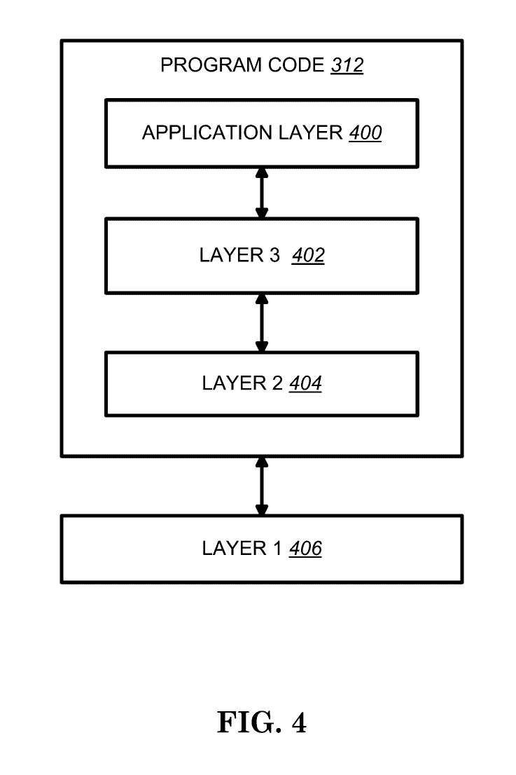

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

3GPP SP-110638 introduces a new study item on proximity-based services (ProSe), i.e., D2D (Device-to-Device) services. The justification and objective of this study item are as follows:

### 3 Justification

Proximity-based applications and services represent a recent and enormous socio-technological trend. The principle of these applications is to discover instances of the applications running in devices that are within proximity of each other, and ultimately also exchange application-related data. In parallel, there is interest in proximity-based discovery and communications in the public safety community.

Current 3GPP specification are only partially suited for such needs, since all such traffic and signalling would have to be routed in the network, thus impacting their performance and adding un-necessary load in the network. These current limitations are also an obstacle to the creation of even more advanced proximity-based applications.

In this context, 3GPP technology, has the opportunity to become the platform of choice to enable proximity-based discovery and communication between devices, and promote a vast array of future and more advanced proximity-based applications.

### 4 Objective

The objective is to study use cases and identify potential requirements for an operator network controlled discovery and communications between devices that are in proximity, under continuous network control, and are under a 3GPP network coverage, for:
1. Commercial/social use
2. Network offloading
3. Public Safety
4. Integration of current infrastructure services, to assure the consistency of the user experience including reachability and mobility aspects

Additionally, the study item will study use cases and identify potential requirements for
5. Public Safety, in case of absence of EUTRAN coverage (subject to regional regulation and operator policy, and limited to specific public-safety designated frequency bands and terminals)

Use cases and service requirements will be studied including network operator control, authentication, authorization, accounting and regulatory aspects.

The study does not apply to GERAN or UTRAN.

In the RAN#66 meeting, a new work item (called “Enhanced LTE Device to Device Proximity Services”) for Release 13 was agreed upon as indicated in 3GPP RP-142311. According to 3GPP RP-142311, the work item will cover the following objectives:
1) Define enhancements (if needed) to D2D discovery to enable the following features:
   a) Type 1 discovery for the partial and outside network coverage scenarios targeting public safety use [RAN1].
2) Define enhancements to D2D communication to enable the following features:
   a) Support the extension of network coverage using L3-based UE-to-Network Relays, including service continuity (if needed), based on Release 12 D2D communication, considering applicability to voice, video. [RAN2, RAN1, RAN3]. (RAN3 involvement pending on progress in the other groups)
   b) Priority of different groups support [RAN2, RAN1, RAN3]. (RAN3 involvement pending on progress in the other groups)
3) Enhance D2D discovery support in the presence of multiple carriers and PLMNs:
   a) Allow D2D transmissions in a non-serving carrier and/or secondary cell belonging to the same and possibly different PLMN as the serving cell [RAN2, RAN1, RAN3].
4) Consider enhancements and specify if needed to support ProSe related MCPTT requirements identified through SA1 work and embraced by SA2 and SA6 ProSe work (e.g. performance of call-set-up) [RAN2].
5) Study additional co-existence issues with adjacent carrier frequencies that may arise due to the new mechanisms being defined [RAN4].
   a) If a need is identified by RAN4, specify potential means to mitigate interference [RAN1].
6) Define additional (if needed) Tx and Rx RF requirements for the UE [RAN4].
7) Define additional (if needed) RRM core requirements [RAN4].

3GPP TR 23.703 introduces a high level concept of solution for supporting UE-Network Relay using Layer 3 Routing based on EPS bearer as follows:

### 6.3.3 Solution R3: UE-Network Relay Using Layer 3 Routing Based on EPS Bearer (Lend Me a EPS Bearer)

### 6.3.3.1 Functional Description

In this case a ProSe UE acting as a relay node carries data traffic to/from a ProSe UE that is out of EUTRA coverage to/from an eNodeB. Following are high level procedures for layer 3 routing:
1) Each of the ProSe Relay UE is part of a ProSe Relay PDN.
2) The ProSe Relay UE creates EPS bearer(s) for a given traffic flow towards the E-UTRAN on the ProSe Relay PDN.
3) The ProSe Relay UE identifies the uplink packet flows coming from the Out of coverage UE, and maps them to a ProSe Relay EPS Bearer.
4) Route the ProSe Relay EPS bearer downlink traffic to the associated UE.
5) IPv4 and IPv6 communication is achieved by creating the appropriate PDN type.

In the case of IPv4 communication, the Relay UE provides the NAT.
Editor's note: The number of UE's that could be supported for relay is FFS.

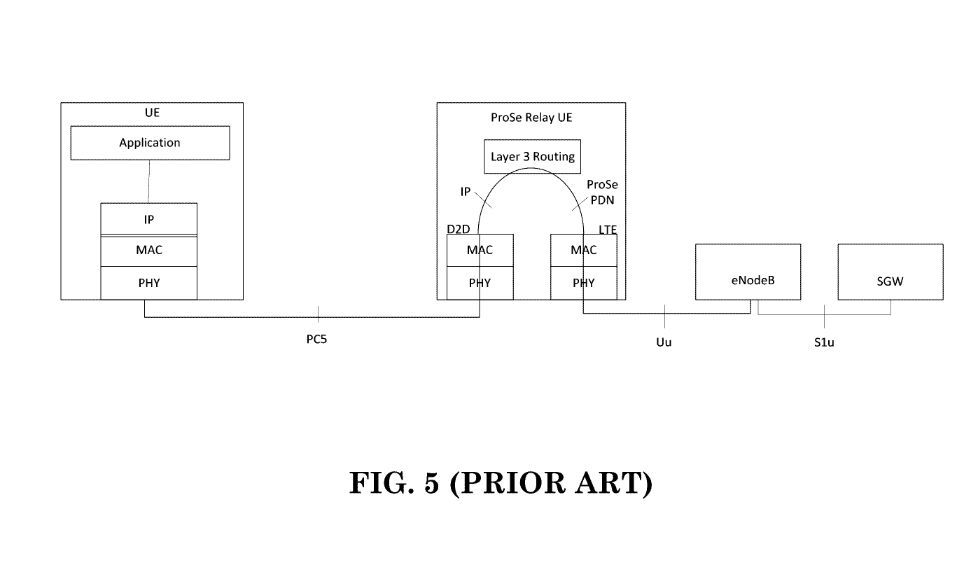

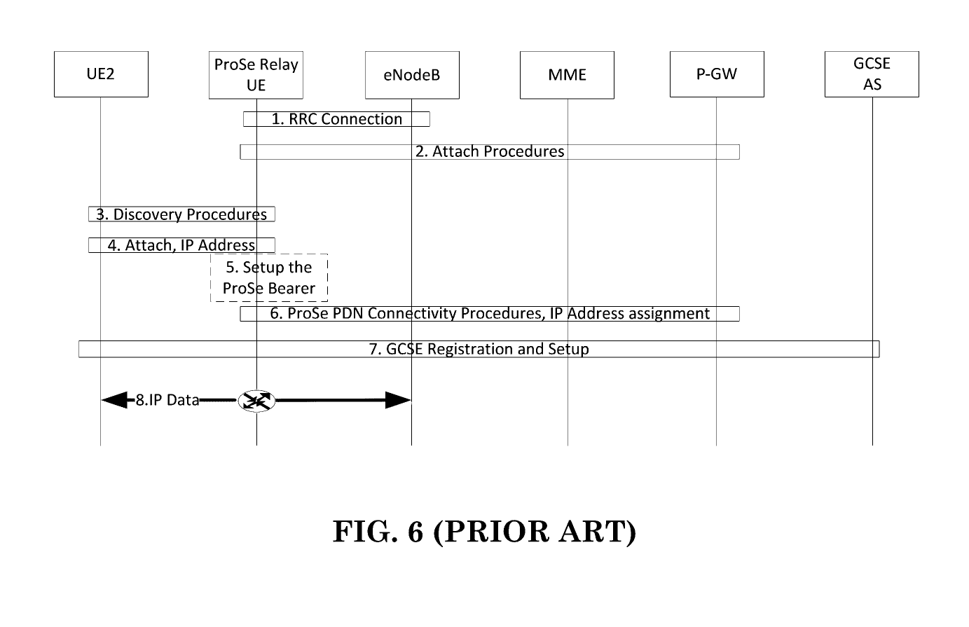

Figure 6.3.3.1-1 [reproduced as FIG. 5 of the present application] shows the UE-Network relay at the ProSe Relay UE. The Layer 3 forwarding maps particular IP traffic to the EPS bearer.

[symbol]

### 6.3.3.2 Procedures

Figure 6.3.3.2-1 [reproduced as FIG. 6 of the present application] describes the procedures for setting up the relay functionality at the UE. The figure assumes that the ProSe Relay is in network coverage and UE2 is out of coverage.

[symbol]

Step1: ProSe Relay UE establishes radio connection to the eNodeB.
Step2: ProSe Relay attaches to the eNodeB. Default PDN could be ProSe PDN or could be some other PDN. In case the default PDN is the ProSe PDN then Step 6 is optional.
Step 3: UE that is out of coverage, discovers ProSe Relay UE.
Step 4: UE attaches to ProSe Relay UE and gets an IP address.
Step 5: Depending the kind of traffic, ProSe Relay UE establishes the ProSe PDN.
Step 6: ProSe Relay establishes a ProSe PDN. The PDN is either managed by the P-GW in case of coverage or could be locally established at the eNodeB. Based on the type of traffic, corresponding QCI bearers are established.
   Editor's note: ProSe PDN could be enhanced to indicate the PDN is being used for ProSe Communication and is FFS.
Step 7: UE2 registers to GCSE AS through the established ProSe PDN.
   Editor's note: The APN that is used for ProSe Relay is FFS.
   Editor's note: Traffic flow mapping from an out of coverage UE to the EPS bearer is FFS.

[symbol]

3GPP TR23.713 introduces a solution for ProSe UE-Network Relays as follows:

### 7.2 Solution for ProSe UE-Network Relays

Editor's note: This clause is intended to document the agreed architecture solution for ProSe UE-Network Relays.

### 7.2.1 Functional Description

### 7.2.1.1 General

The UE-to-Network Relay function will be specified based upon an evolution of the ProSe functionality already documented in TS 23.303 [3].

### 7.2.1.2 Unicast Relaying

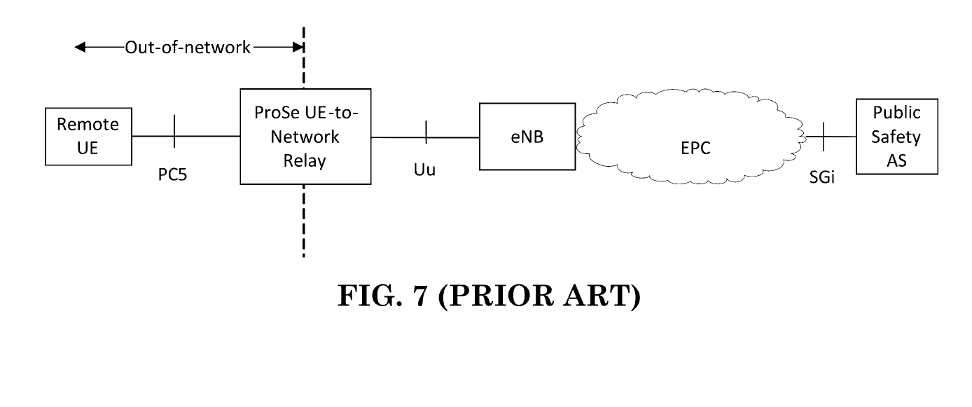

The ProSe UE-to-Network Relay function includes support for the relay of unicast traffic (UL and DL) between Remote UEs that are not served by E-UTRAN and the network. The ProSe UE-to-Network Relay provides generic L3 forwarding function that can relay any type of IP traffic that is relevant for public safety communication. The ProSe UE-Network Relay is a Layer-3 relay (Figure 7.2.1.2-1 [reproduced as FIG. 7 of the present application]).

[symbol]

The One-to-One Communication between Remote UE and ProSe UE-Network Relay is described in clause 7.1.

7.2.1.3 eMBMS Relay Support

The UE-to-Network Relay function will include support for the relay of eMBMS to Remote UEs served by the UE-to-Network Relay. This functionality allows for the relaying of eMBMS traffic related to specific TMGIs as requested by served Remote UEs. As part of this functionality:
The UE-to-Network Relay shall advertise the availability of specific TMGIs when this has been requested by served Remote UEs.
UEs that request the relay to advertise the availability of a certain TMGI and to relay the related traffic need to keep alive a soft state in the Relay so that the relay can continue to perform TMGI monitoring and the related traffic forwarding. When this soft state is not kept alive for a given TMGI, the UE-to-Network Relay stops advertising availability of the TMGI and stops the relaying of the related eMBMS traffic.
The UE-to-Network Relay shall send the eMBMS traffic over a one to many direct communication link to the Remote UEs, using as a destination Layer 2 address a ProSe Layer 2 Group ID which will have been previously provided by the relay to the Remote UEs.
The ProSe UE-to-Network Relay does not terminate eMBMS or higher layer security procedures used to secure the media transmitted over the eMBMS bearers. The UE-to-Network Relay just transparently transfers, over the PC5 one-to-many link, the traffic it receives.

### 7.2.1.4 Support of ECGI Announcement

Some applications require the knowledge of the ECGI of the cell serving the UE e.g. to perform counting of UEs served by the same cell.

For the purpose of these applications, when a UE is behind a ProSe UE-to-Network relay (so it is a Remote UE for this ProSe UE-to-Network relay), the serving cell of this Remote UE is the cell serving the ProSe UE-to-Network relay. So, the announcement of the ECGI by a ProSe UE-to-Network relay allows Remote UEs served by a ProSe UE-to-Network relay to receive the value of the ECGI of the cell serving the ProSe UE-to-Network relay. This enables the reporting of this ECGI for these applications.

An example of an application requirement may be the dynamic activation of eMBMS in the cell where the ProSe UE-to-Network relay is camping, if there is a sufficient number of devices behind the ProSe UE-to-Network relay, in order to avoid e.g. unicast distribution of multiple application streams of the same content in unicast mode to different devices under the same ProSe UE-to-Network relay (note that aggregation of unicast streams at an agent in the ProSe UE-to-Network relay is not possible when the relay is behaving as Layer 3 device).

The ECGI obtained by a relay should be used by applications that can handle it appropriately (e.g. impact on location service relaying on ECGI should be understood and alternate location methods may be more appropriate in certain domain of application). So, it is application dependent whether the ECGI obtained by a relay can be used or not and how the application reports it to the server (i.e. whether an explicit indication is needed this is obtained by a relay, or not).
Editor's Note: This feature needs to be supported if the dynamic activation of eMBMS content distribution based on application layer ECGI reporting is supported in Rel-13. The interaction between the dynamic establishment of eMBMS based on application layer ECGI reporting and any potential RAN-level counting needs to be studied as part of the work on dynamic activation of eMBMS content distribution based on application layer ECGI reporting.

### 7.2.2 Procedures

Editor's note: Describes the high-level operation, procedures and information flows for the solution.

### 7.2.2.1 Relay Discovery and One-to-One Communication Establishment

The ProSe UE-Network Relay may attach to the network (if not already attached) and establish a PDN connection that can be used for relaying of traffic to/from Remote UEs.

[symbol]

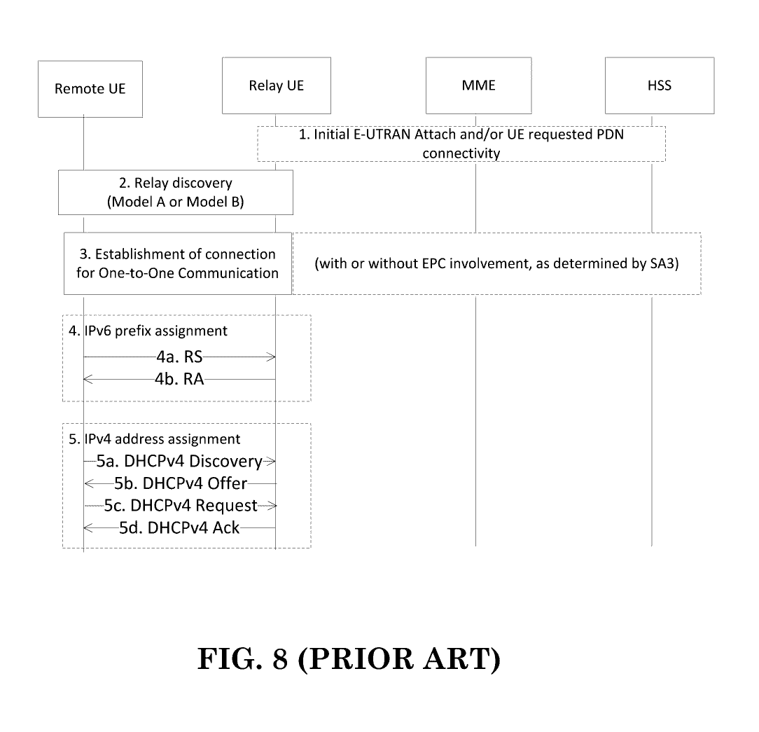

### Figure 7.2.2-1: Call Flow for ProSe UE-Network Relay [Reproduced as FIG. 8 of the Present Application]

1. The ProSe UE-Network Relay performs initial E-UTRAN Attach (if not already attached) and/or establishes a PDN connection for relaying (if no appropriate PDN connection for this relaying exists). In case of IPv6, the ProSe UE-Network Relay obtains IPv6 prefix via prefix delegation function from the network as defined in TS 23.401 [7].
2. The Remote UE performs discovery of a ProSe UE-Network Relay using Model A or Model B discovery. The details of this procedure are described in clause 6.
3. The Remote UE selects a ProSe UE-Network Relay and establishes a connection for One-to-One Communication. The details of this procedure are described in clause 7.1.
   NOTE 1: Whether the authentication of the Remote UE involves the EPC will be decided by SA3.
4. When IPv6 is used on PC5 the Remote UE performs IPv6 Stateless Address auto-configuration, the Remote UE shall send a Router Solicitation message (step 4a) to the network using as Destination Layer-2 ID the Layer-2 ID of the Relay in order to solicit a Router Advertisement message (step 4b) as specified in IETF RFC 4862 [6]. The Router Advertisement messages shall contain the assigned IPv6 prefix. After the Remote UE receives the Router Advertisement message, it constructs a full IPv6 address via IPv6 Stateless Address auto-configuration in accordance with IETF RFC 4862 [6]. However, the Remote UE shall not use any identifiers defined in TS 23.003 [8] as the basis for generating the interface identifier. For privacy, the Remote UE may change the interface identifier used to generate the full IPv6 address, as defined in TS 23.221 [9] without involving the network. The Remote UE shall use the auto-configured IPv6 address while sending packets.
5. When IPv4 is used on PC5 the Remote UE uses DHCPv4 [10]. The Remote UE shall send DHCPv4 Discovery (step 5a) message using as Destination Layer-2 ID the Layer-2 ID of the Relay. The ProSe UE-Network Relay acting as a DHCPv4 Server sends the DHCPv4 Offer (step 5b) with the assigned Remote UE IPv4 address. When the Remote UE receives the lease offer, it sends a DHCP REQUEST message containing the received IPv4 address (step 5c). The ProSe UE-Network Relay acting as DHCPv4 server sends a DHCPACK message to the Remote UE (step 5d) including the lease duration and any other configuration information that the client might have requested. On receiving the DHCPACK message, the Remote UE completes the TCP/IP configuration process.
NOTE 2: The DHCPv4 client may skip the DHCPv4 Discovery phase, and send DHCPv4 Request message in broadcast as the first message in accordance with the DHCPv4 renewal process.
   7.2.2.2 TMGI Advertisement and eMBMS Traffic Relay

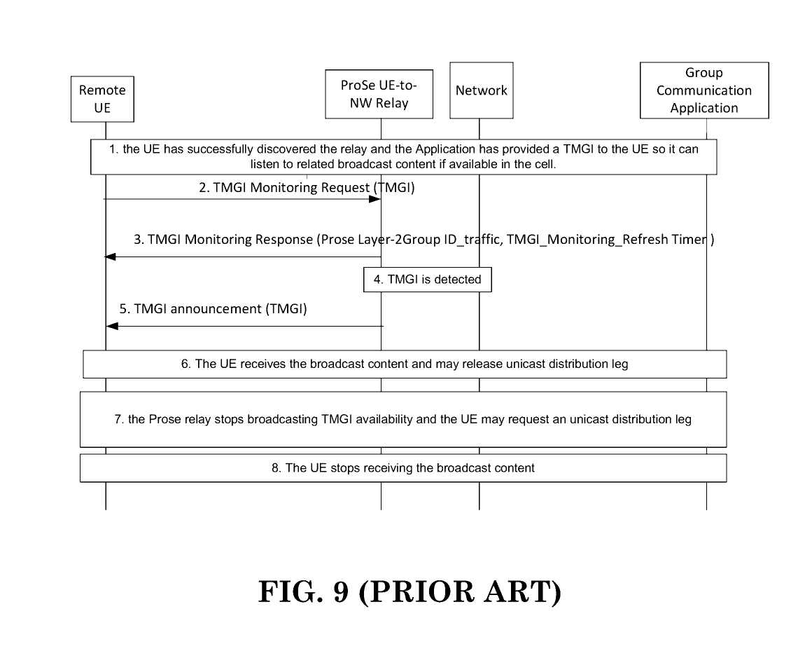

The following procedure illustrated in Figure 7.2.2.2-1 [reproduced as FIG. 9 of the present application] here below is used by a ProSe-enabled Public safety UE to request a ProSe UE-to-Network relay to start monitoring a specific TMGI availability and that the ProSe UE-to-Network relay broadcasts this TMGI on a broadcast channel when it is detected on the MCCH of the serving cell. The eMBMS traffic related to this TMGI, if available, is also forwarded to the remote UE's served by the relay over a one-to-many link identified by a specific ProSe Layer-2 Group ID provided by the Relay when the procedure is executed.

[symbol]

1) The UE has successfully discovered the ProSe UE to Network Relay and has obtained (perhaps after a one to one communication sessions with the relay) from a Group communication application a TMGI the UE should use to receive related eMBMS content. The UE obtains the TMGI it is interested in either by static configuration or by interaction with the Group Communication Application. This interaction can happen before or after the UE has joined the relay.
2) The UE sends to the ProSe UE-to-Network relay a TMGI Monitoring Request (TMGI) where TMGI is the value obtained at step 1.
3) The ProSe UE-to-Network relay acknowledges receipt of the request in step 2 with a TMGI Monitoring Response (ProSe Layer 2 Group ID_traffic, TMGI_Monitoring_Refresh Timer). The ProSe Layer 2 Group ID_traffic is used to forward to Remote UEs the eMBMS content related to the TMGI value received at step 2. The TMGI_Monitoring_Refresh Timer (configurable in the ProSe UE to network relay) is provided to the UE so that when this timer elapses the UE shall execute the TMGI monitoring request procedure if it still needs to monitor the TMGI. If a UE does not execute the TMGI Monitoring Request procedure when this TMGI_Monitoring_Refresh Timer expires in the UE and no other UE in executes the refresh procedure for this TMGI, then when the TMGI_Monitoring_Refresh Timer for the TMGI expires in the relay, the relay shall stop monitoring the TMGI and also to forward any related content if it was doing so.
4) The ProSe UE-to-Network Relay detects the TMGI it has been requested to monitor
5) Upon detection of the TMGI, the ProSe UE-to-Network relay broadcasts availability of the TMGI by sending a TMGI Announcement (TMGI) message over a broadcast channel. This is repeated with a configurable (in the ProSe UE to Network Relay) repetition interval which should normally be smaller than the TMGI_Monitoring_Refresh Timer. The value of the TMGI may be used by devices discovering the UE-to-Network relay as a preference criterion for Relay selection, if they are interested in the TMGI the relay is advertising.
6) The UE detects the announcement of step 5 and subsequently starts to receive the broadcast content on the PC5 ProSe one-to-many link associated to the Prose Layer-2 Group ID_traffic defined at step 3, and may release unicast distribution leg if any was being used.
7) Upon detection of loss of TMGI, the ProSe UE-to-Network relay stops broadcasting availability of the TMGI. It may also (optionally) send a positive indication of loss of TMGI so as to accelerate loss of TMGI detection in the UE (not shown in the procedure). The UE may request a unicast distribution leg from the GCSE AS
8) The UE stops receiving the broadcast content on the PC5 ProSe one-to-many signalling link associated to the Prose Group Layer-2 ID_traffic defined at step 3.
   NOTE 1: the relative ordering between step 7 and 8 may be dependent on when the eMBMS content becomes unavailable in the cell.

### 7.2.2.3 Cell ID Announcement Procedure

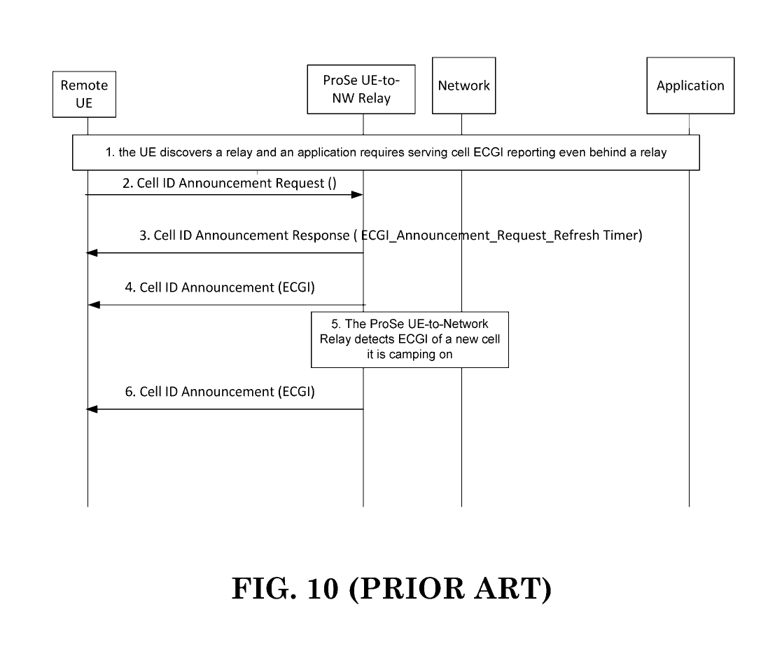

The following procedure outlined in Figure 7.2.2.3-1 [reproduced as FIG. 10 of the present application] allows an authorized public safety UE, based on application requirements outside the scope of the present procedure, to request a ProSe UE-to-Network Relay to announce the EUTRAN Cell Global ID (ECGI) of the Cell serving the ProSe UE-to-Network Relay. [symbol]
1) A UE has discovered a ProSe UE-to-Network relay and an application requires serving cell ECGI reporting even when it is behind a relay (i.e. the application benefits from this value even if it is the value of the cell serving the relay and not the UE directly).
2) The UE sends to the ProSe UE-to-Network relay a Cell ID Announcement Request( ) to support the needs of such application
3) The ProSe UE-to-Network relay acknowledges receipt of the request in step 2 with a Cell ID Announcement Request (ECGI_Announcement_Request_Refresh Timer). The ECGI_Announcement_Request_Refresh Timer, (configurable in the ProSe UE to network relay) is provided to the UE so that when this timer elapses the UE shall repeat the Cell ID Announcement Request procedure if it still needs obtain the ECGI. If a UE does not execute the Cell ID Announcement Request procedure when this ECGI_Announcement_Request_Refresh Timer expires and no other UE request ECGI announcement before the ECGI_Announcement_Request_Refresh timer expires in the UE-to-Network relay, then the relay shall stop announcing the ECGI of the serving cell.
4) The ProSe UE-to-Network Relay announces the ECGI of the serving cell by sending a Cell ID Announcement (ECGI) on a broadcast channel. This is repeated periodically with a configurable frequency (normally Higher than the one related to the ECGI_Announcement_Request_Refresh Timer) until there is no UE requesting to announce the ECGI as determined by the ECGI_Announcement_Request_Refresh Timer running in the ProSe UE-to-Network relay.
5) The ProSe UE-to-Network Relay may at any time detect the ECGI of a new serving cell it is happening to be camping on
6) Step 5 triggers the ProSe UE-to-Network Relay to announce the ECGI of the serving cell immediately and repeat it periodically with a configurable frequency as in step 4 until there is no UE requesting to announce the ECGI as determined by the ECGI_Announcement_Request_Refresh Timer running in the ProSe UE-to-Network relay.

### 7.2.3 Impact on Existing Entities and Interfaces

Editor's note: Impacts on existing nodes or functionality will be added.

### 7.2.4 Topics for Further Study for ProSe UE-Network Relays

The following issues need to be resolved:
It is FFS whether the TMGI advertisement by the UE-to-Network relay happens by using Direct Communications one to many using a shared ProSe Layer 2 ID to all UEs the UE-to-Network relay serves; or using a ProSe Layer 2 ID dedicated for a specific application layer group related to the TMGI; or whether the TMGI advertisement happens using discovery signalling.
It is FFS whether the messages used by the remote UE to request a UE-to-Network relay to monitor a certain TMGI are at the access stratum or non-access stratum layer.
It is FFS whether a security association between the UE and the UE-to Network relay is per UE or per ProSe Application Group.
It is FFS if the IP Address preservation is supported when the Remote UE moves out of the ProSe UE-Network Relay coverage—It is FFS whether for IPv4 the Prose UE-to-Network relay will have to implement NAT functionality.
It is FFS whether and how the EPC is aware of the remote UE's presence (e.g. for the purpose of authorisation, QoS, LI, etc.) in absence of direct NAS signalling connection between the Remote UE and the MME.
It is FFS how a ProSe UE-to-Network Relay performs priority handling of Remote UEs.

### 7.2.5 Conclusions on ProSe UE-Network Relays

The ProSe UE-Network Relay is a Layer-3 relay (i.e. an IP router), as agreed in Rel-12 ProSe.

3GPP TR23.303 provides that ProSe UE-to-Network Relaying shall include certain functions. In addition, 3GPP TR 23.303 also captures the procedures of One-to-many ProSe Direct Communication as follows:

### 4.5.4 ProSe UE-to-Network Relaying

ProSe UE-to-Network Relaying shall include the following functions:
ProSe Direct discovery following Model A or Model B can be used in order to allow the Remote UE to discover ProSe UE-to-Network Relay(s) in proximity.
ProSe Direct discovery that can be used in order to allow the Remote UE to discover L2 address of the ProSe UE-to-Network Relay to be used by the Remote UE for IP address allocation and user plane traffic corresponding to a specific PDN connection supported by the ProSe UE-to-Network Relay.
Act as an “announcing” or “discoveree” UE on the PC5 reference point supporting direct discovery.
Act as a default router to the Remote UEs forwarding IP packets between the UE-ProSe UE-to-Network Relay point-to-point link and the corresponding PDN connection.
Handle Router Solicitation and Router Advertisement messages as defined in IETF RFC 4861[10].
Act as DHCPv4 Server and stateless DHCPv6 Relay Agent.
Act as a NAT if IPv4 is used replacing the locally assigned IPv4 address of the Remote UE with its own.
Map the L2 link ID used by the Remote UE as Destination Layer-2 ID to the corresponding PDN connection supported by the ProSe UE-to-Network Relay.
NOTE: The aspects of the radio layers for the PC5 reference point are defined in RAN specifications.

[symbol]

### 5.4 Procedures for ProSe Direct Communication

### 5.4.1 One-to-Many ProSe Direct Communication General

One-to-many ProSe Direct Communication is applicable only to ProSe-enabled Public Safety UEs and when authorised, can apply when the UE is served by E-UTRAN and when the UE is outside of E-UTRA coverage.

One-to-many ProSe Direct Communication has the following characteristics:
One-to-many ProSe Direct Communication is connectionless. Thus there is no signalling over PC5 control plane.
There is no QoS support.
There is no support for priority handling.
The radio layer provides a user plane communication service for transmission of IP packets between UEs engaged in direct communication.
Members of a group share a secret from which a group security key may be derived to encrypt all user data for that group.
Authorisation for one-to-many ProSe Direct Communication is configured in the UE by the ProSe Function using PC3 reference point.
ProSe UE configuration parameters (e.g. including ProSe Group IP multicast addresses, ProSe Group IDs, Group security material, radio related parameters) are configured in the UE.

### 5.4.2 One-to-Many ProSe Direct Communication Transmission

This procedure is applicable to authorized ProSe-enabled Public Safety UEs.

[symbol]

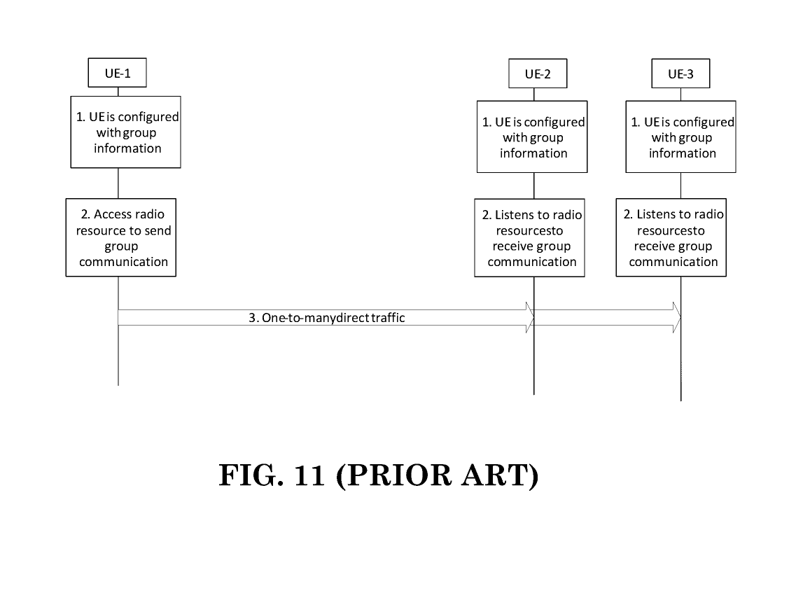

### Figure 5.4.2-1: One-to-Many ProSe Direct Communication Transmission [Reproduced as FIG. 11 of the Present Application]

1. UE is configured with the related information for one-to-many ProSe Direct Communication as defined in clause 4.5.1.1.2.3.3. The UE obtains the necessary group context (ProSe Layer-2 Group ID, ProSe Group IP multicast address) to transmit IP-layer transport of data, and also the radio resource related parameters used for the Direct Communication.
2. The originating UE finds the appropriate radio resource to conduct one-to-many ProSe Direct Communication as specified in clause 4.5.1.1.2.3.1.
   The protocol data unit passed for transmission to the Access Stratum is associated with a Layer-3 protocol data unit type. In this release of the specification the following Layer-3 protocol data types are supported: IP packet and Address Resolution Protocol packet (see RFC 826 [28]).
   The packet passed for transmission to the Access Stratum is associated with the corresponding Source Layer-2 ID and Destination Layer-2 ID. The Source Layer-2 ID is set to the ProSe UE ID assigned from the ProSe Key Management Function. The Destination Layer-2 ID is set to the ProSe Layer-2 Group ID.
      NOTE: More details about step 2 to be defined in RAN specifications.
3. The originating UE sends the IP data to the IP multicast address using the ProSe Layer-2 Group ID as Destination Layer-2 ID.

### 5.4.3 One-to-Many ProSe Direct Communication Reception

This procedure is only applicable to authorized ProSe-enabled Public Safety UEs.

[symbol]

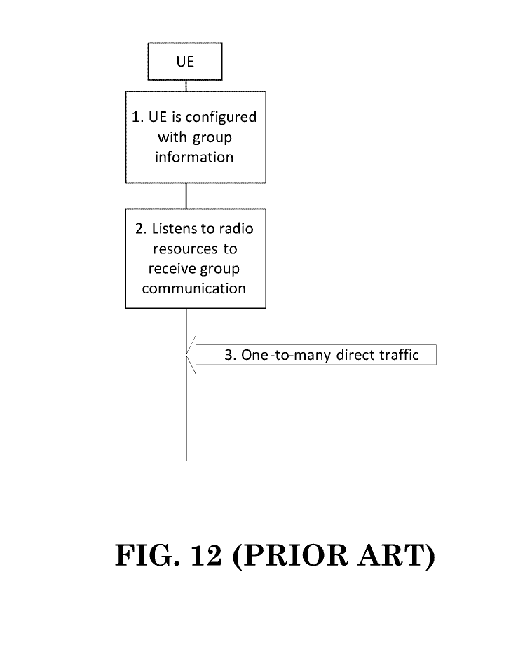

### Figure 5.4.3-1: One-to-Many Direct Communication Reception [Reproduced as FIG. 12 of the Present Application]

1. UE is configured with the related information for one-to-many ProSe Direct Communication as defined in clause 4.5.1.1.2.3.3. The UE obtains the necessary group context (ProSe Layer-2 Group ID, Group IP multicast address) to receive IP-layer transport of data, and also the radio resource related parameters used for the Direct Communication.
2. The receiving UE listens to the allocated radio resource to receive one-to-many ProSe Direct Communication.
   NOTE: More details about step 2 to be defined in RAN specifications.
3. The receiving UE filters out the received frames based on the ProSe Layer-2 Group ID contained in the Destination Layer-2 ID and if it matches one of the configured Group IDs, it delivers the enclosed packet to the upper layers. The IP stack filters the received packets based on the Group IP multicast address.
   The protocol data unit passed to the upper layers is associated with a Layer-3 protocol data unit type. In this release of the specification the following Layer-3 protocol data types are supported: IP packet and Address Resolution Protocol packet (see RFC 826 [28]).

3GPP R2-151326 [10] Introduced Association Between Sidelink (SL) Bearer and Uu Bearer as Follows:

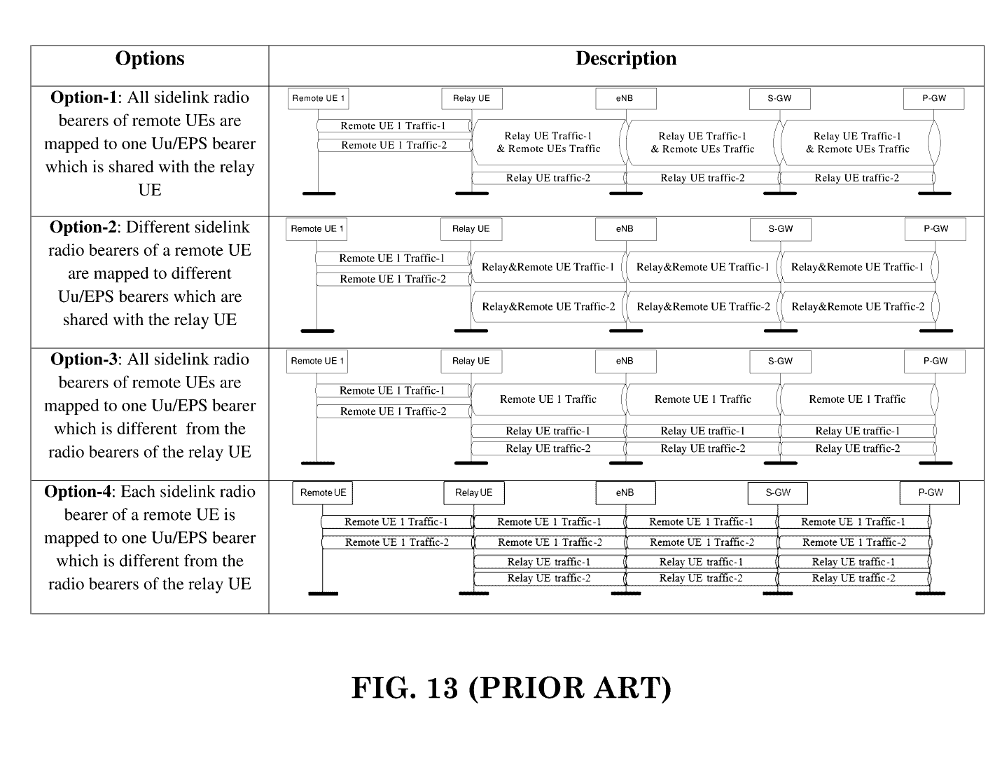

For sidelink unicast communication, there could be multiple sidelink radio bearers between a remote UE and a relay UE to transfer data of different services (e.g., voice, video and etc.). Correspondingly one or more uplink/downlink radio bearers could be established in the Uu interface. One open issue is how the sidelink radio bearers are mapped to the Uu radio bearers. The possible options are listed in Table-1 [reproduced as FIG. 13 of the present application], while the pros and cons of each option are analyzed in Table-2.

### Table-1 Options of Mapping Between Sidelink RBs to Uu Bearers [Reproduced as FIG. 13 of the Present Application]

[symbol]

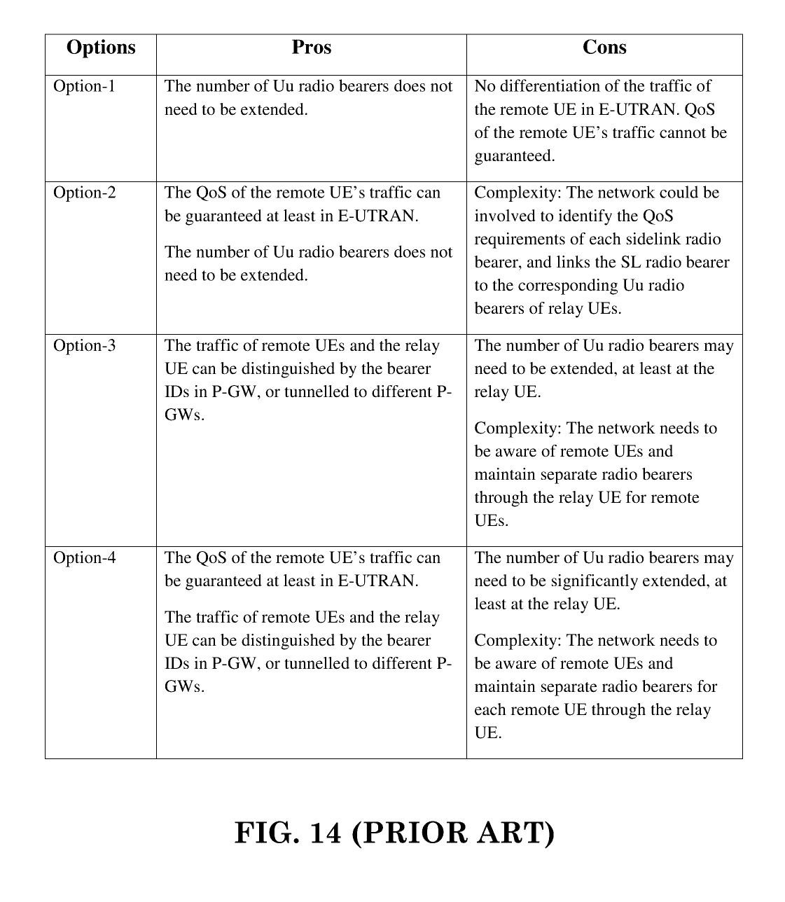

### Table-2 Pros and Cons of Each User Plane Option [Reproduced as FIG. 14 of the Present Application]

[symbol]

3GPP R2-151290 considered that Relay UE may replace source IP address with its own IP address for a packet received from a Remote UE before the packet is sent to the network as follows:

Step 6: Change of Path from PC5 to WAN and Strong of the Path Association

Once the UE2NW relay UE filters out the packet destined to NW from PC5 interface, it should change path from PC5 (between the remote UE and the UE2NW relay UE) to WAN (between the UE2NW relay UE and the NW). We think it is done in the upper layer since it is L3 relay. For instance, the UE2NW relay UE modifies IP address as to make a source IP address from the remote UE to its own. Then the UE2NW relay UE will store the required path association information between PC5 and WAN.

3GPP TS 36.508 specified the association between EPS bearer, radio bearer and logical channel as follows:

### 4.8.2.1.7 DRB Configurations

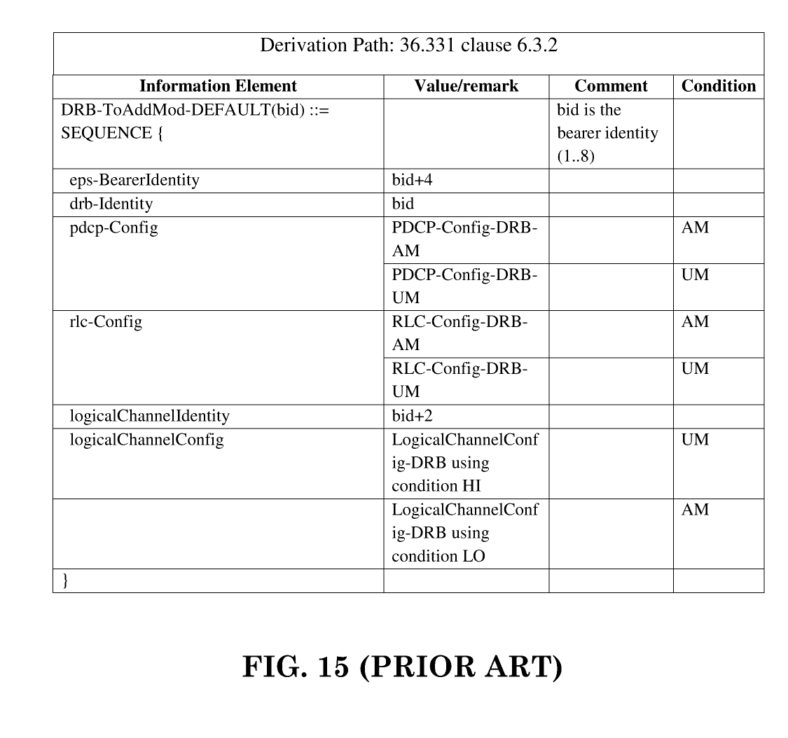

### Table 4.8.2.1.7-1: DRB-ToAddMod-DEFAULT(Bid) [Reproduced as FIG. 15 of the Present Application]

3GPP TS36.321 specified MAC sub-header format and related content as follows:

### 6.1 Protocol Data Units

### 6.1.1 General

A MAC PDU is a bit string that is byte aligned (i.e. multiple of 8 bits) in length. In the figures in subclause 6.1, bit strings are represented by tables in which the most significant bit is the leftmost bit of the first line of the table, the least significant bit is the rightmost bit on the last line of the table, and more generally the bit string is to be read from left to right and then in the reading order of the lines. The bit order of each parameter field within a MAC PDU is represented with the first and most significant bit in the leftmost bit and the last and least significant bit in the rightmost bit.

MAC SDUs are bit strings that are byte aligned (i.e. multiple of 8 bits) in length. An SDU is included into a MAC PDU from the first bit onward.

The UE shall ignore the value of Reserved bits in downlink MAC PDUs.

### 6.1.2 MAC PDU (DL-SCH and UL-SCH Except Transparent MAC and Random Access Response, MCH)

A MAC PDU consists of a MAC header, zero or more MAC Service Data Units (MAC SDU), zero, or more MAC control elements, and optionally padding; as described in Figure 6.1.2-3.

Both the MAC header and the MAC SDUs are of variable sizes.

A MAC PDU header consists of one or more MAC PDU subheaders; each subheader corresponds to either a MAC SDU, a MAC control element or padding.

A MAC PDU subheader consists of the six header fields R/R/E/LCID/F/L but for the last subheader in the MAC PDU and for fixed sized MAC control elements. The last subheader in the MAC PDU and subheaders for fixed sized MAC control elements consist solely of the four header fields R/R/E/LCID. A MAC PDU subheader corresponding to padding consists of the four header fields R/R/E/LCID.

[symbol]

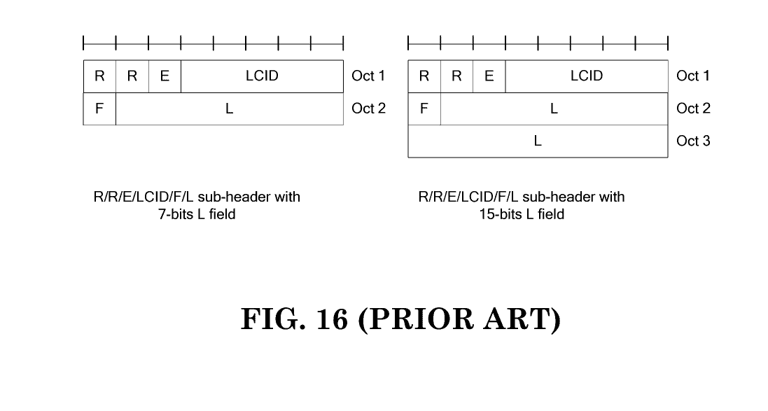

### Figure 6.1.2-1: R/R/E/LCID/F/L MAC Subheader [Reproduced as FIG. 16 of the Present Application]

[symbol]

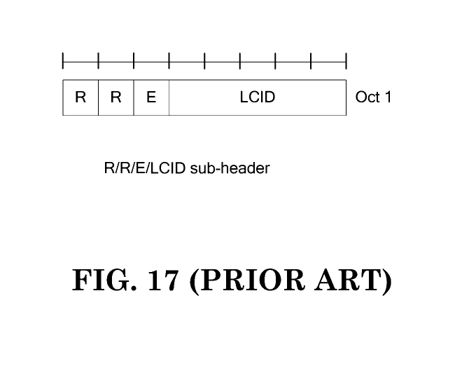

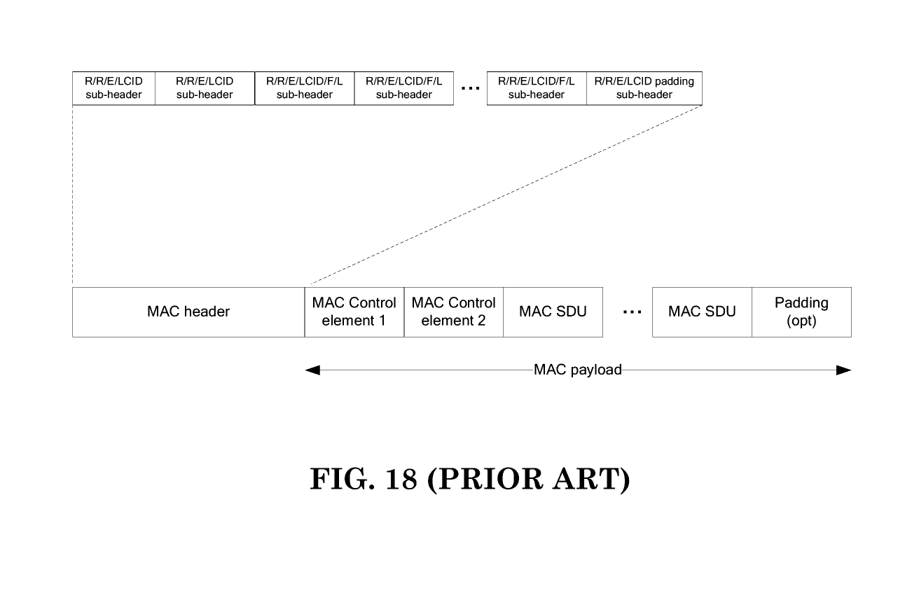

### Figure 6.1.2-2: R/R/E/LCID MAC Subheader [Reproduced as FIG. 17 of the Present Application]

MAC PDU subheaders have the same order as the corresponding MAC SDUs, MAC control elements and padding.

MAC control elements are always placed before any MAC SDU.

Padding occurs at the end of the MAC PDU, except when single-byte or two-byte padding is required. Padding may have any value and the UE shall ignore it. When padding is performed at the end of the MAC PDU, zero or more padding bytes are allowed.

When single-byte or two-byte padding is required, one or two MAC PDU subheaders corresponding to padding are placed at the beginning of the MAC PDU before any other MAC PDU subheader.

A maximum of one MAC PDU can be transmitted per TB per UE. A maximum of one MCH MAC PDU can be transmitted per TTI.

[symbol]

### 6.2 Formats and Parameters

### 6.2.1 MAC Header for DL-SCH, UL-SCH and MCH

The MAC header is of variable size and consists of the following fields:
LCID: The Logical Channel ID field identifies the logical channel instance of the corresponding MAC SDU or the type of the corresponding MAC control element or padding as described in tables 6.2.1-1, 6.2.1-2 and 6.2.1-4 for the DL-SCH, UL-SCH and MCH respectively. There is one LCID field for each MAC SDU, MAC control element or padding included in the MAC PDU. In addition to that, one or two additional LCID fields are included in the MAC PDU, when single-byte or two-byte padding is required but cannot be achieved by padding at the end of the MAC PDU. The LCID field size is 5 bits;
L: The Length field indicates the length of the corresponding MAC SDU or variable-sized MAC control element in bytes. There is one L field per MAC PDU subheader except for the last subheader and subheaders corresponding to fixed-sized MAC control elements. The size of the L field is indicated by the F field;
F: The Format field indicates the size of the Length field as indicated in table 6.2.1-3. There is one F field per MAC PDU subheader except for the last subheader and subheaders corresponding to fixed-sized MAC control elements. The size of the F field is 1 bit. If the size of the MAC SDU or variable-sized MAC control element is less than 128 bytes, the value of the F field is set to 0, otherwise it is set to 1;
E: The Extension field is a flag indicating if more fields are present in the MAC header or not. The E field is set to “1” to indicate another set of at least R/R/E/LCID fields. The E field is set to “0” to indicate that either a MAC SDU, a MAC control element or padding starts at the next byte;
R: Reserved bit, set to “0”.

The MAC header and subheaders are octet aligned.

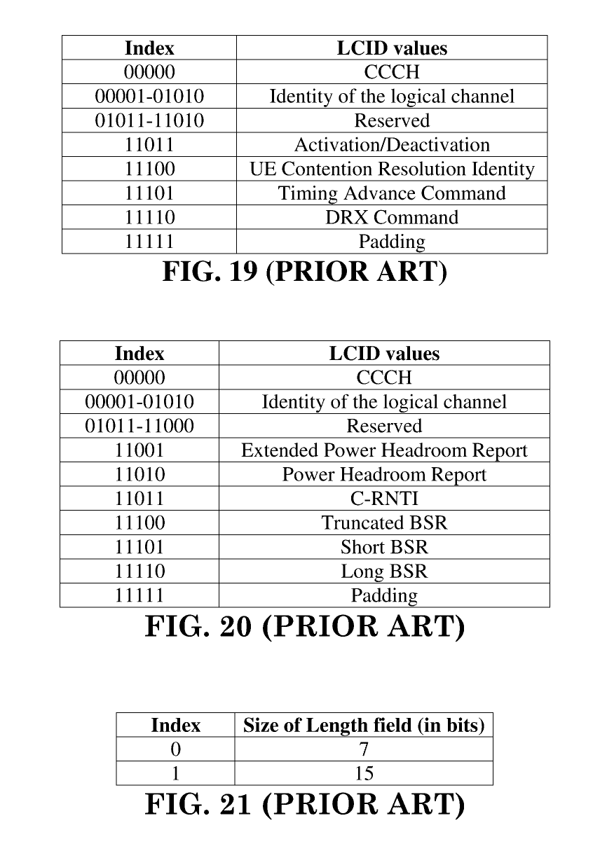

### Table 6.2.1-1 Values of LCID for DL-SCH [Reproduced as FIG. 19]

[symbol]

### Table 6.2.1-2 Values of LCID for UL-SCH [Reproduced as FIG. 19 of the Present Application]

[symbol]

### Table 6.2.1-3 Values of F Field [Reproduced as FIG. 20 of the Present Application]

[symbol]

As discussed in 3GPP RP-142311, the work item will support L3-based UE-to-Network Relays considering applicability to voice or video service. Thus, as discussed in 3GPP TS 23.107, such relay communication could take the concept of QoS (Quality of Service) control into account.

According to 3GPP R2-151326, if the QoS of Remote UE's traffic should be guaranteed, Uu radio bearer (such as Data Radio Bearer, DRB, as discussed in 3GPP TS 36.331) used for each traffic in one Remote UE should be different, as Option-2 or Option-4 discussed in 3GPP R2-151326. For Option-2, the network could be involved to identify the QoS requirements of each sidelink radio bearer (SLRB), and links the SLRB to the corresponding DRB of Relay UEs. According to 3GPP R2-151290, when a Relay UE should forward to the network the traffic received from a Remote UE, the Relay UE may modify IP address to make a source IP address from the Remote UE be its own. As such, Option-2 described in 3GPP R2-151326 could not be applicable since it may increase complexity for the network to distinguish each IP packet with the Relay UE's source IP address that is sent by the Relay UE or by the Remote UE. Compare to that, Option-4 described in 3GPP R2-151326 seems more applicable since in the network's point of view the traffic of Remote UEs and the Relay UE could be distinguished by EPS (Evolved Packet System) bearer IDs in P-GW (Packet Data Networks Gateway), and in Relay UE's point of view the traffic of each Remote UE could be distinguished based on separate Uu logical channel.

Based on the current 3GPP TS 36.331 and TS 36.321, each EPS bearer is associated with one DRB, and each DRB is associated with one Uu logical channel. As such, UE could identify which traffic is carried on which DRB based on identity of Uu logical channel. In addition, each UE could be configured with total 8 DRBs (i.e., drb-Identity).

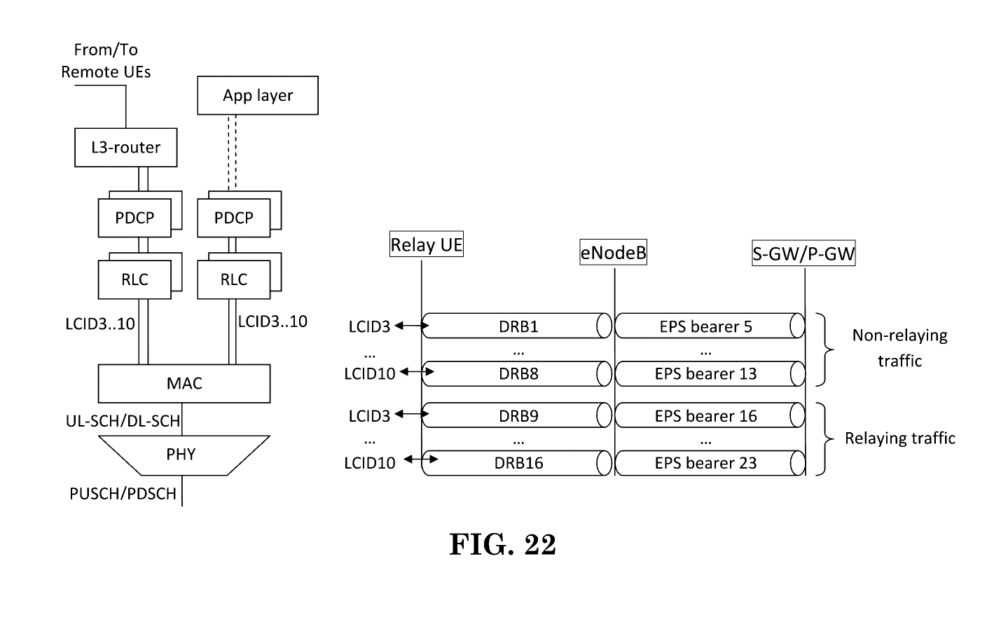

Based on the Option-4 architecture discussed in 3GPP R2-151326, in order to minimize the impact, the original 8 DRBs specified in 3GPP TS 36.331 may be used for Relay UE its own traffic. Furthermore, another set of DRBs, called extended DRB (eDRB), is considered. For example, if Remote UEs need another 8 different DRBs for supporting their services and differentiable for eNB, then Relay UE may establish up to 16 Uu logical channels and associate each Uu logical channel with one radio bearer (e.g., either DRB or eDRB). FIG. 22 illustrates an example of association between Uu logical channel, radio bearer, and EPS bearer. DRB1 to DRB8, shown in FIG. 22, are original DRBs specified in 3GPP TS 36.331 and TS 36.508, and DRB9 to DRB16 are extended DRBs used for relaying traffic.

Based on the current MAC specification (3GPP TS 36.321), the number of identity of Uu logical channel is 8 (for each transmission direction), and it is not sufficient to support more than 8 Uu logical channels. One possible alternative resolution for this issue is to specify more identity of Uu logical channel. However, the alternative resolution needs a lot of reserved value of LCID (Logical Channel Identity—as discussed in Table 6.2.1-1 and Table 6.2.1-2 of 3GPP TS 36.321 v11.2.0 which are reproduced as FIGS. 19 and 20) that may reduce usability in the future.

Another alternative resolution is to specify that each current identity of Uu logical channel could be shared by one DRB and one eDRB if configured. In order to reduce the complexity of the eNB scheduling, the concept of transmitting traffic of DRB and eDRB sharing the same identity of Uu logical channel in one transport block (TB) could be considered. Therefore, another issue appears to be how Relay UE or eNB would know if the received traffic corresponding to a Uu logical channel belongs to an associated DRB or to an eDRB. There are two potential solutions for the issue.

Solution 1:

A Relay UE is configured to establish a Uu logical channel with a LCID related to a eDRB, wherein the LCID may be shared by another original DRB. For differentiating relaying traffic (i.e., Remote UE's traffic) and non-relaying traffic (i.e., Relay UE's its own traffic), the Relay UE constructs a MAC (Medium Access Control) PDU (Protocol Data Unit) with both MAC subheader indicating the LCID for relaying traffic and MAC subheader also indicating the LCID for non-relaying traffic, and makes those MAC subheaders and corresponding MAC SDUs differentiable by implicit rule (e.g., including order).

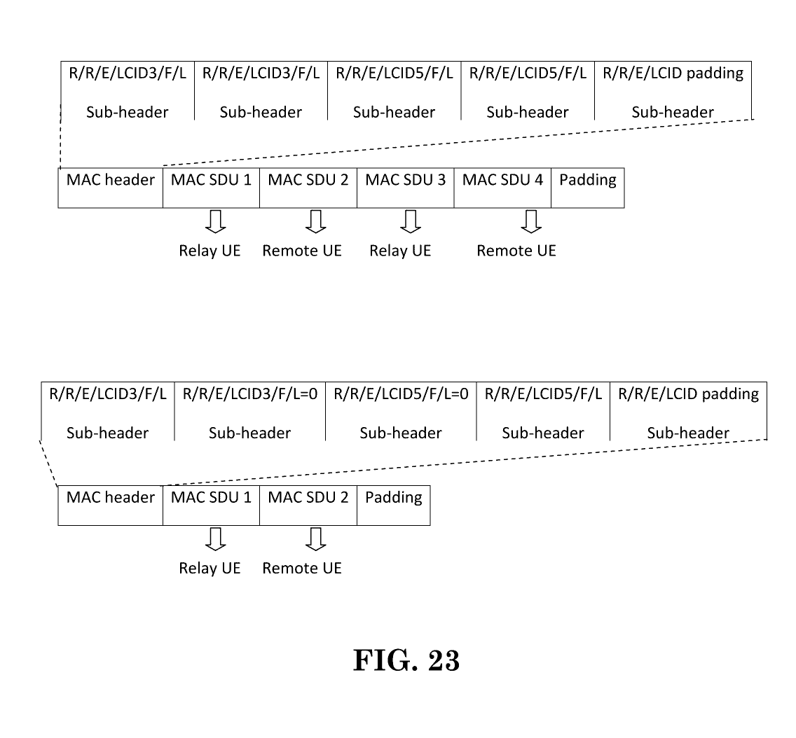

In addition, the corresponding MAC SDUs for these MAC subheaders could be optionally included. For instance, the Relay UE establishes a first Uu logical channel with a LCID used for its own traffic and a second Uu logical channel with the LCID used for relaying traffic of a Remote UE. When data for the first Uu logical channel and the second Uu logical channel is available for UL (Uplink) transmission, the Relay UE could place a first MAC subheader together with a corresponding MAC SDU (Service Data Unit) for the first Uu logical channel and a second MAC subheader together with a corresponding MAC SDU for the second Uu logical channel in the same TB. In case only data either for the first Uu logical channel or the second Uu logical channel is available for UL transmission, the Relay UE could still place both such MAC subheaders in a TB but could set the L-field included in a MAC subheader associated with the Uu logical channel without data available for UL transmission to ‘0’ so eNB could understand that no MAC SDU corresponding to the MAC subheader exists in the TB. For the reception of TB from eNB, the Relay UE could use the same principle to correctly distinguish and deliver each MAC SDU to the related Uu logical channel. FIG. 23 illustrates an exemplary embodiment of Solution 1. This solution could be applied to Relay UE, eNB or both.

Solution 2:

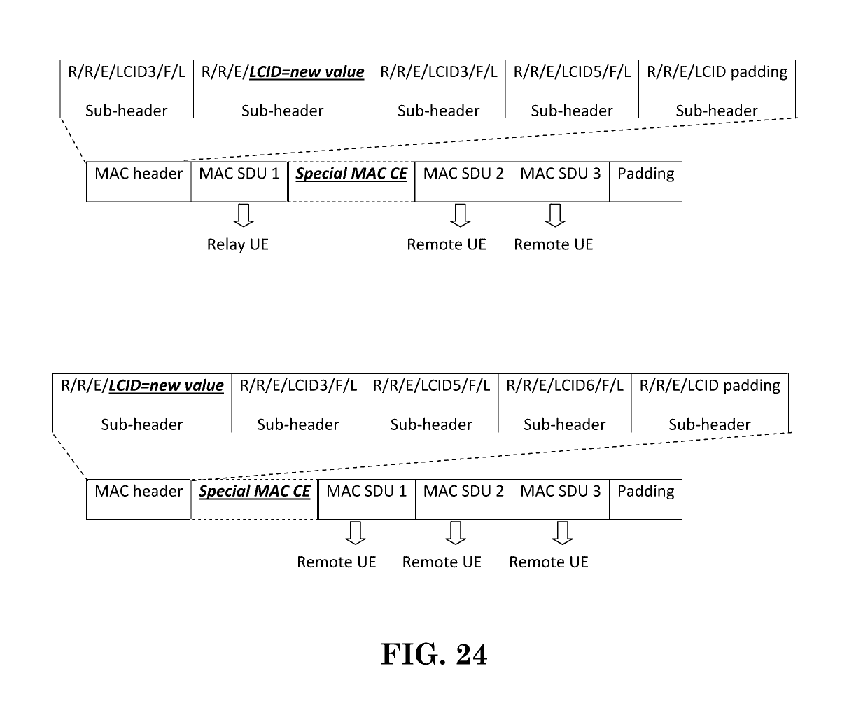

A new explicit indication used to distinguish Uu logical channel for relaying traffic (i.e., Remote UE's traffic) or non-relaying traffic (i.e., Relay UE's its own traffic) is proposed. The indication could be considered as a boundary between at least two regions in a TB, where one region is used for identifying the relaying traffic and the other region is used for identifying the non-relaying traffic. The indication could be a special MAC control element (CE). More specifically, this special MAC control element may have a fixed size; for instance zero bit (e.g., only MAC subheader). For reception of TB from the eNB, the MAC subheader corresponding to the indication could be inserted where the Relay UE could understand that each MAC SDU following the special MAC control element is associated with either relaying traffic or non-relaying traffic. For reception of TB from the Relay UE, eNB could use the same principle to correctly distinguish and deliver each MAC SDU to the related Uu logical channel. Compare to Solution 1, this solution has better resource efficiency. FIG. 24 illustrates an exemplary embodiment of Solution 2. This solution could be applied to Relay UE, eNB or both.

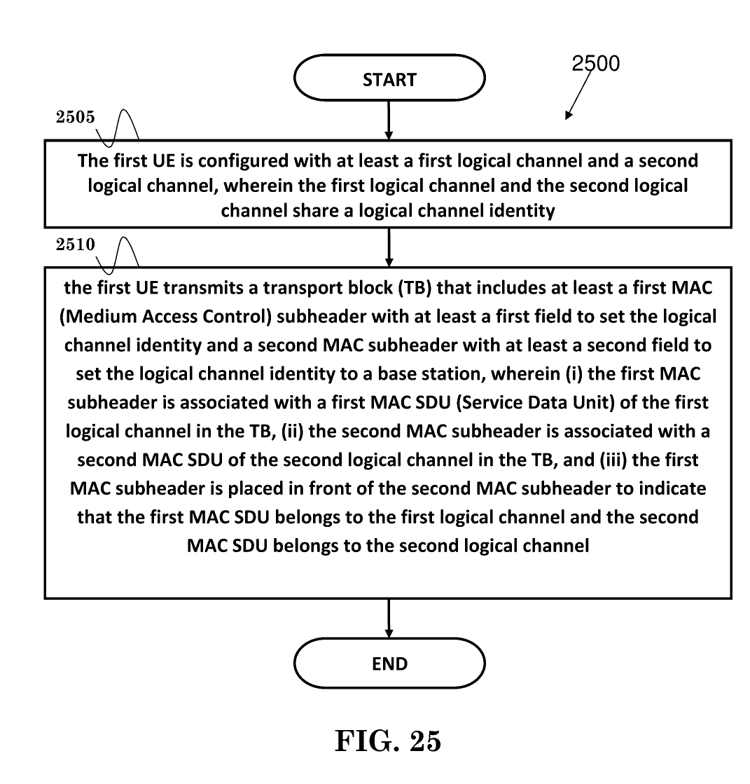

FIG. 25 is a flow chart 2500 from the perspective of a first user that supports ProSe relay communication, in accordance with one exemplary embodiment. In step 2505, the first UE is configured with at least a first logical channel and a second logical channel, wherein the first logical channel and the second logical channel share a logical channel identity. In step 2510, the first UE transmits a transport block (TB) that includes at least a first MAC (Medium Access Control) subheader with at least a first field to set the logical channel identity and a second MAC subheader with at least a second field to set the logical channel identity to a base station, wherein (i) the first MAC subheader is associated with a first MAC SDU (Service Data Unit) of the first logical channel in the TB, (ii) the second MAC subheader is associated with a second MAC SDU of the second logical channel in the TB, and (iii) the first MAC subheader is placed in front of the second MAC subheader to indicate that the first MAC SDU belongs to the first logical channel and the second MAC SDU belongs to the second logical channel.

In one embodiment, wherein the first MAC SDU belongs to the first logical channel and the second MAC SDU belongs to the second logical channel. Furthermore, the first MAC SDU may be in front of the second MAC SDU to differentiate channels to which the first MAC SDU and the second MAC SDU belong. Furthermore, the first MAC subheader associated with the first MAC SDU could be always in front of the second MAC subheader associated with the second MAC SDU in the TB.

In one embodiment, an L-field in the first MAC subheader would not be set to zero ‘0’ if the first MAC SDU corresponding to the first MAC subheader is included in the TB, and would be set to zero ‘0’ if the first MAC SDU corresponding to the first MAC subheader is not included in the TB. Furthermore, the second MAC SDU is included in the TB.

Similarly, an L-field in the second MAC subheader would not be set to zero ‘0’ if the second MAC SDU corresponding to the second MAC subheader is included in the TB, and would be set to zero ‘0’ if the second MAC SDU corresponding to the second MAC subheader is not included in the TB. Furthermore, the first MAC SDU is included in the TB.

In one embodiment, the logical channel identity associated with the first logical channel is a LCID value, and the logical channel identity associated with the second logical channel is also a LCID value. Furthermore, the first logical channel could be associated with a DRB, and the second logical channel could be associated with an extended DRB which is different from the DRB. Alternatively, the first logical channel could be associated with an extended DRB, and the second logical channel could be associated with a DRB which is different from the extended DRB. Also, each of the first MAC subheader and the second MAC subheader could be a R/R/E/LCID/F/L subheader. In addition, each of the first field and the second field could be a “LCID” field.

Referring back to FIGS. 3 and 4, in one embodiment from the perspective of a first UE that supports ProSe relay communication, the device 300 includes a program code 312 stored in memory 310 of the transmitter. The CPU 308 could execute program code 312 to enable the first UE (i) to be configured with at least a first logical channel and a second logical channel, wherein the first logical channel and the second logical channel share a logical channel identity, (ii) to transmit a transport block (TB) that includes at least a first MAC (Medium Access Control) subheader with at least a first field to set the logical channel identity and a second MAC subheader with at least a second field to set the logical channel identity to a base station, wherein (i) the first MAC subheader is associated with a first MAC SDU (Service Data Unit) of the first logical channel in the TB, (ii) the second MAC subheader is associated with a second MAC SDU of the second logical channel in the TB, and (iii) the first MAC subheader is placed in front of the second MAC subheader to indicate that the first MAC SDU belongs to the first logical channel and the second MAC SDU belongs to the second logical channel. In addition, the CPU 308 can execute the program code 312 to perform all of the above-described actions and steps or others described herein.

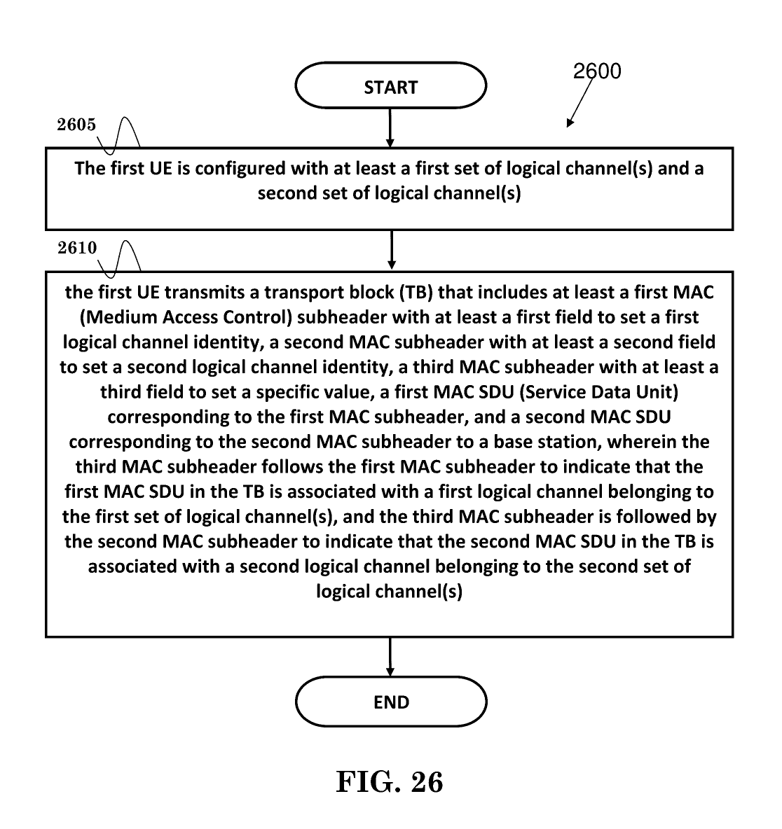

FIG. 26 is a flow chart 2600 from the perspective of a first UE that supports ProSe relay communication in accordance with one exemplary embodiment. In step 2605, the first UE is configured with at least a first set of logical channel(s) and a second set of logical channel(s).

In one embodiment, the first set of logical channel(s) could include at least one logical channel. In one embodiment, the second set of logical channel(s) could include at least one logical channel.

In step 2610, the first UE transmits a transport block (TB) that includes at least a first MAC (Medium Access Control) subheader with at least a first field to set a first logical channel identity, a second MAC subheader with at least a second field to set a second logical channel identity, a third MAC subheader with at least a third field to set a specific value, a first MAC SDU (Service Data Unit) corresponding to the first MAC subheader, and a second MAC SDU corresponding to the second MAC subheader to a base station, wherein the third MAC subheader follows the first MAC subheader to indicate that the first MAC SDU in the TB is associated with a first logical channel belonging to the first set of logical channel(s), and the third MAC subheader is followed by the second MAC subheader to indicate that the second MAC SDU in the TB is associated with a second logical channel belonging to the second set of logical channel(s).

In one embodiment, the UE, which could be configured with a first set of logical channel(s) and a second set of logical channel(s), could transmit a TB which could include at least a first MAC subheader with at least a first field to set a first logical channel identity and a first MAC SDU to a base station. If the TB also includes a third MAC subheader with at least a third field to set a specific value, the third MAC subheader is followed by the first MAC subheader to indicate that the first MAC SDU corresponding to the first MAC subheader in the TB is associated with a second logical channel belonging to the second set of logical channel(s). However, if the TB excludes the third MAC subheader, the absence of the third MAC subheader indicates that any MAC SDU in the TB is associated with the first set of logical channel(s).

In one embodiment, the first logical channel belonging to the first set of logical channel(s) is associated with the first logical channel identity, and the second logical channel belonging to the second set of logical channel(s) is associated with the second logical channel identity.

In one embodiment, the first logical channel identity is used to identify the first logical channel in the first set of logical channel(s), and the second logical channel identity is used to identify the second logical channel in the second set of logical channel(s).

In one embodiment, the first logical channel identity could be the same as the second logical channel identity. In one embodiment, the first logical channel identity could be different from the second logical channel identity.

In one embodiment, the first logical channel identity is a LCID value, and the second logical channel identity is also a LCID value. Furthermore, the specific value could be a defined reserved value. In addition, the specific value could be a LCID value which is different from the first logical channel identity and the second logical channel identity. Also, the first logical channel belonging to the first set of logical channel(s) could be associated with a DRB and the second logical channel belonging to the second set of logical channel(s) could be associated with an extended DRB which is different from the DRB. Alternatively, the first logical channel belonging to the first set of logical channel(s) could be associated with an extended DRB and the second logical channel belonging to the second set of logical channel(s) could be associated with a DRB which is different from the extended DRB. In addition, each of the first MAC subheader and the second MAC subheader could be a R/R/E/LCID/F/L subheader. Also, the third MAC subheader could be a R/R/E/LCID subheader. Also, each of the first field, the second field, and the third field could be a “LCID” field.

Referring back to FIGS. 3 and 4, in one embodiment from the perspective of a first UE that supports ProSe relay communication, the device 300 includes a program code 312 stored in memory 310 of the transmitter. The CPU 308 could execute program code 312 to enable the first UE (i) to be configured with at least a first set of logical channel(s) and a second set of logical channel(s), (ii) to transmit a transport block (TB) that includes at least a first MAC (Medium Access Control) subheader with at least a first field to set a first logical channel identity, a second MAC subheader with at least a second field to set a second logical channel identity, a third MAC subheader with at least a third field to set a specific value, a first MAC SDU (Service Data Unit) corresponding to the first MAC subheader, and a second MAC SDU corresponding to the second MAC subheader to a base station, wherein the third MAC subheader follows the first MAC subheader to indicate that the first MAC SDU in the TB is associated with a first logical channel belonging to the first set of logical channel(s), and the third MAC subheader is followed by the second MAC subheader to indicate that the second MAC SDU in the TB is associated with a second logical channel belonging to the second set of logical channel(s). Furthermore, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method of a first user equipment (UE) for supporting ProSe (Proximity-based Service) relay communication, comprising:
the first UE is configured with at least a first logical channel and a second logical channel, wherein the first logical channel and the second logical channel share a logical channel identity;
the first UE transmits a transport block (TB) that includes at least a first MAC (Medium Access Control) subheader with at least a first field to set the logical channel identity and a second MAC subheader with at least a second field to set the logical channel identity to a base station,
wherein the first MAC subheader is associated with a first MAC SDU (Service Data Unit) of the first logical channel in the TB and the second MAC subheader is associated with a second MAC SDU of the second logical channel in the TB, and the first MAC subheader is placed in front of the second MAC subheader is used to indicate that the first MAC SDU belongs to the first logical channel and the second MAC SDU belongs to the second logical channel.

2. The method of claim 1, wherein:
a data length field in the first MAC subheader is not set to zero ‘0’ if the first MAC SDU corresponding to the first MAC subheader is included in the TB, and is set to zero ‘0’ if the first MAC SDU corresponding to the first MAC subheader is not included in the TB, and the second MAC SDU is included in the TB; and
a data length-field in the second MAC subheader is not set to zero ‘0’ if the second MAC SDU corresponding to the second MAC subheader is included in the TB, and is set to zero ‘0’ if the second MAC SDU corresponding to the second MAC subheader is not included in the TB, and the first MAC SDU is included in the TB.

3. The method of claim 1, wherein the logical channel identity is a LCID value.

4. The method of claim 1, wherein:
the first logical channel is a logical channel established for communication between the base station and the first UE, and the second logical channel is a logical channel established for communication between a second UE and the base station; or
the first logical channel is a logical channel established for communication between the base station and a second UE, and the second logical channel is a logical channel established for communication between the first UE and the base station.

5. The method of claim 1, wherein each of the first MAC subheader and the second MAC subheader is a R/R/E/LCID/F/L subheader.

6. The method of claim 1, wherein the first UE is a Relay UE.

7. The method of claim 4, wherein the second UE is a Remote UE.

8. A method of a first user equipment (UE) for supporting ProSe (Proximity-based Service) relay communication, comprising:
the first UE is configured with at least a first set of logical channel(s) and a second set of logical channel(s);
the first UE transmits a transport block (TB) that includes at least a first MAC (Medium Access Control) subheader with at least a first field to set a first logical channel identity, a second MAC subheader with at least a second field to set a second logical channel identity, a third MAC subheader including at least a third field to set a specific value, a first MAC SDU (Service Data Unit) corresponding to the first MAC subheader, and a second MAC SDU corresponding to the second MAC subheader to a base station,
wherein the third MAC subheader follows the first MAC subheader to indicate that the first MAC SDU in the TB is associated with a first logical channel belonging to the first set of logical channel(s), and the third MAC subheader is followed by the second MAC subheader to indicate that the second MAC SDU in the TB is associated with a second logical channel belonging to the second set of logical channel(s).

9. The method of claim 8, wherein the first logical channel identity is used to identify the first logical channel in the first set of logical channel(s) and the second logical channel identity is used to identify the second logical channel in the second set of logical channel(s), and the first logical channel identity is the same as the second logical channel identity or is different from the second logical channel identity.

10. The method of claim 8, wherein the specific value is a LCID value which is different from the first logical channel identity and the second logical channel identity, and the first logical channel identity is a LCID value and the second logical channel identity is also a LCID value.

11. The method of claim 8, wherein:
the first logical channel belonging to the first set of logical channel(s) is a logical channel established for communication between the base station and the first UE, and the second logical channel belonging to the second set of logical channel(s) is a logical channel established for communication between a second UE and the base station; or
the first logical channel belonging to the first set of logical channel(s) is a logical channel established for communication between the base station and a second UE, and the second logical channel belonging to the second set of logical channel(s) is a logical channel established for communication between the first UE and the base station.

12. The method of claim 8, wherein each of the first MAC subheader and the second MAC subheader is a R/R/E/LCID/F/L subheader.

13. The method of claim 8, wherein the third MAC subheader is a R/R/E/LCID subheader.

14. The method of claim 8, wherein the first UE is a Relay UE.

15. The method of claim 11, wherein the second UE is a Remote UE.

16. A first UE, configured with at least a first logical channel and a second logical channel sharing a logical channel identity, for supporting ProSe (Proximity-based Service) relay communication, comprising:
a control circuit;
a processor installed in the control circuit; and
a memory installed in the control circuit and operatively coupled to the processor;
wherein the processor is configured to execute a program code stored in the memory to:
transmit a transport block (TB) that includes at least a first MAC (Medium Access Control) subheader with at least a first field to set the logical channel identity, a second MAC subheader with at least a second field to set the logical channel identity to a base station,
wherein the first MAC subheader is associated with a first MAC SDU (Service Data Unit) of the first logical channel in the TB and the second MAC subheader is associated with a second MAC SDU of the second logical channel in the TB, and the first MAC subheader is placed in front of the second MAC subheader to indicate the first MAC SDU that belongs to the first logical channel and the second MAC SDU belongs to the second logical channel.

17. The first UE of claim 16, wherein:
a data length-field in the first MAC subheader is not set to zero ‘0’ if the first MAC SDU corresponding to the first MAC subheader is included in the TB, and is set to zero ‘0’ if the first MAC SDU corresponding to the first MAC subheader is not included in the TB, and the second MAC SDU is included in the TB; and
a data length-field in the second MAC subheader is not set to zero ‘0’ if the second MAC SDU corresponding to the second MAC subheader is included in the TB, and is set to zero ‘0’ if the second MAC SDU corresponding to the second MAC subheader is not included in the TB, and the first MAC SDU is included in the TB.

18. A first UE, configured with at least a first set of logical channel(s) and a second set of logical channel(s), for supporting ProSe (Proximity-based Service) relay communication, comprising:
a control circuit;
a processor installed in the control circuit; and
a memory installed in the control circuit and operatively coupled to the processor;
wherein the processor is configured to execute a program code stored in the memory to:
transmit a transport block (TB) that includes at least a first MAC (Medium Access Control) subheader with at least a first field to set a first logical channel identity, a second MAC subheader with at least a second field to set a second logical channel identity, a third MAC subheader with at least a third field to set a specific value, a first MAC SDU (Service Data Unit) corresponding to the first MAC subheader, and a second MAC SDU corresponding to the second MAC subheader to a base station,
wherein the third MAC subheader follows the first MAC subheader to indicate that the first MAC SDU in the TB is associated with a first logical channel belonging to the first set of logical channel(s), and the third MAC subheader is followed by the second MAC subheader to indicate that the second MAC SDU in the TB is associated with a second logical channel belonging to the second set of logical channel(s).

19. The first UE of claim 18, wherein the first logical channel identity is used to identify the first logical channel in the first set of logical channel(s) and the second logical channel identity is used to identify the second logical channel in the second set of logical channel(s), and the first logical channel identity is the same as the second logical channel identity or is different from the second logical channel identity.

20. The first UE of claim 18, wherein the specific value is a LCID value which is different from the first logical channel identity and the second logical channel identity, and the first logical channel identity is a LCID value and the second logical channel identity is also a LCID value.
